(19) United States
(12) Patent Application Publication
(10) Pub. No.: US 2026/0148543 A1
(43) Pub. Date: May 28, 2026

(54) PROBABILISTIC FEATURE MATCHING IN IMAGES

(71) Applicant: International Business Machines Corporation, Armonk, NY (US)

(72) Inventors: Mattia RIGOTTI, Basel (CH); Thomas FRICK, Winterthur (CH); Cezary Jerzy SKURA, Adliswil (CH); Andrea BARTEZZAGHI, Rueschlikon (CH); Filip Michal JANICKI, Zurich (CH); Adelmo Cristiano Innocenza MALOSSI, Schönenberg (CH)

(21) Appl. No.: 18/959,600

(22) Filed: Nov. 25, 2024

(51) Int. Cl. G06V 10/84; G06V 10/42

(52) U.S. Cl. CPC G06V 10/84; G06V 10/421

(57) ABSTRACT

In some implementations, a computing device may receive one or more reference images respectively having an indication of a reference object of interest within the one or more reference images. The computing device may generate a probability map associated with a target image based at least in part on matching scores that are associated with the reference object. The computing device may identify an object of interest within the target image based at least in part on the probability map.

### BACKGROUND

Object recognition in an image may be used to identify common objects for organization of images, security questions, or image editing, among other examples. Some object recognition techniques use algorithms with complexity that is cubic relative to a size of the image (in data) or object. Some object recognition techniques use a model trained using a large-scale training process to identify common objects. In this way, the object recognition may be accurate, but may have a complexity that consumes computing and power resources in a way that may limit scalability.

### SUMMARY

In some implementations, a method comprises receiving one or more reference images respectively having an indication of a reference object of interest within the one or more reference images. The method comprises generating a probability map associated with a target image based at least in part on matching scores that are associated with the reference object. method further comprises identifying an object of interest within the target image based at least in part on the probability map.

In some implementations, a computer program product comprises one or more computer readable storage media and program instructions collectively stored on the one or more computer readable storage media. The program instructions comprise program instructions to receive an indication of a reference object of interest within one or more reference images. The program instructions also comprise program instructions to generate a probability map associated with a target image based at least in part on matching scores that are associated with the reference object. The program instructions further comprise program instructions to identify an object of interest within the target image based at least in part on the probability map.

In some implementations, a system comprises one or more devices configured to receive user input that indicates a reference object of interest within one or more reference images. The one or more devices also generate a probability map associated with a target image based at least in part on matching scores that are associated with the reference object. The one or more devices further identify an object of interest within the target image based at least in part on the probability map.

### BRIEF DESCRIPTION OF THE DRAWINGS

FIGS. 1A-1F are diagrams of an example implementation described herein.

FIG. 2 is a diagram of an example implementation described herein.

FIG. 3 is a diagram of an example computing environment in which systems and/or methods described herein may be implemented.

FIG. 4 is a diagram of example components of one or more devices of FIGS. 1 and 2.

FIGS. 5-7 are flowcharts of example processes associated with a probabilistic feature matching in images.

### DETAILED DESCRIPTION

The following detailed description of example implementations refers to the accompanying drawings. The same reference numbers in different drawings may identify the same or similar elements.

Foundation models have improved machine learning model development and application, pivoting from a paradigm centered on training use case-tailored models on task-specific data to a paradigm where single generalist models are pretrained on diverse large-scale data, then fine-tuned for a wide range of tasks. Specifically in computer vision, models such as segment anything model (SAM), contrastive language-image pre-training (CLIP), and self-supervised backbones such as self-distillation, no labels (DINO), and DINOv2 have unlocked powerful and versatile visual functionalities like object detection, semantic segmentation and expressive embeddings that are at the core of a multitude of diverse applications.

The SAM (or other prompted segmentation algorithm) may use a prompting paradigm in computer vision by enabling fine-grained image segmentation through interactive prompts in the form of points or bounding boxes. Both visual prompting via inpainting and segment anything generative pre-trained transformer (SegGPT) and Painter may use visual prompting models trained on few-shot image segmentation datasets. These models operate on a reference image and corresponding segmentation masks, and generate a segmentation mask for a target image based on the reference. Although this disclosure references SAM as an example type of prompted segmentation algorithm, other types of prompted segmentation algorithms may be used in place of the SAM in any of the examples provided herein.

Other models may use a training-free method for one-shot segmentation leveraging pretrained image encoders in conjunction with SAM or another prompted segmentation algorithm. The labeled pixels within an annotated mask on a reference image may be assigned to pixels on target images using a similarity evaluation, such as a cosine similarity matrix of their corresponding encoded patches. The target patch of maximum similarity is then used to generate a segmentation mask for the target object.

Other models (e.g., Matcher) use a bidirectional matching procedure to match encoded reference and target image patches using the Hungarian algorithm, which is an accurate but slow assignment algorithm with worst case complexity being cubic relative to a size of a problem. One-shot (or few shot) segmentation may be implemented by assigning annotated encoded pixels on reference images to encoded target pixels, which may then serve as prompts for SAM (or another prompted segmentation algorithm) to produce segmentation mask proposals on the target images. A set of mask proposals may be scored and either accepted or rejected.

Other models may use a framework for model-assisted labeling of visual inspection defects through an interactive annotation process leveraging gradient-based explainability to improve efficiency of provided labels.

In some aspects described herein, foundation models may be used in novel ways to support new workflows in technical domains, such as visual inspection. In some aspects, a computing device may use a novel framework for image segmentation guided by visual prompting that leverages vision foundation models. For example, the computing device may use techniques that integrate multiple large-scale pretrained models to address challenges of segmentation tasks with limited and sparsely annotated data interactively provided by a user.

In some aspects, the computing device may combine a frozen feature extraction backbone with a scalable and efficient probabilistic feature correspondence (e.g., “soft matching”) procedure derived from Optimal Transport to couple pixels between reference and target images. In some aspects, the computing device may use a pretrained segmentation model to translate course user input (e.g., user scribbles) into reference masks and matched target pixels into output target segmentation masks. In this way, the computing device may use a versatile and fast training-free architecture for image segmentation by visual prompting. The techniques described may improve efficiency (e.g., conserve computing and power resources) and provide scalability for real-time interactive image segmentation by visual prompting relative to other techniques and models. In some aspects, the techniques described herein may be used for technical visual inspection use cases.

In some aspects, the computing device may perform interactive segmentation guided by visual prompting on a reference image. In some aspects, the computing device may perform prompting and reference segmentation, where a user provides coarse input (e.g., scribbles) on the reference image indicating an object class (object of interest) to be identified (e.g., labeled) on one or more target images. In some aspects, the coarse input may be used as a sparse prompt for SAM (or another prompted segmentation algorithm), which then is used to generate a reference mask. The computing device may then perform matching, where soft probabilistic matching is used to generate a probability map over pixels of each target image quantifying matches to pixels in the reference mask. The computing device may then sample points from the probability map, clustered and used for mask generation. Mask generation may include using clustered points as sparse prompts to SAM (or another prompted segmentation algorithm) to generate mask proposals, which may be filtered based on SAM's (or another prompted segmentation algorithm's) intersection over union (IoU) predictions and aggregated into the mask output.

Based at least in part on the computing device using the techniques described herein, the computing device may support an interactive segmentation workflow where users can provide visual prompts by coarsely annotating reference images through simple inputs (e.g., scribbles) and interact in real-time with the resulting segmentation masks. For example, the computing device may receive input from a user to correct the segmentation mask or provide additional annotations.

In some aspects, the computing device may perform prompting and reference segmentation that provides a way for the computing device to receive, from a user, prompts for a segmentation pipeline with coarse visual prompts (e.g., scribbles) instead of requiring detailed segmentation masks.

In some aspects, the techniques described herein comprise a computationally-efficient version matching that supports low-latency segmentation and avoids cubically scaling (based at least in part on image sizes or numbers of patches) used in other models (e.g., Hungarian algorithm). In this way, the computing device may perform object detection in a practical way for an interactive workflow. For example, instead of using less-efficient bipartite matching (e.g., Hungarian algorithm-based) based on a cosine similarity between reference features and target features, the computing device may use an optimal transport (OT) approach. The OT approach may be based at least in part on a quadratic cosine similarity matrix as a cost matrix for the object detection. This may support the computing device to motivate a sequence of approximations for an efficient implementation of the matching procedure. For example, the computing device may introduce an entropic regularization, then consider the case of large regularization limit where the solution to the OT problem converges to the geometric mean of softmaxed cosine similarity maps between individual reference features and target feature maps (where the averaging is conducting across reference features). This operation may have quadratically scaling complexity in the number of image patches. Additionally, the operation may support a scalable implementation by approximating the softmax computation of reference-target feature similarities through random Fourier features (RFF).

In some aspects, the computing device may integrate an improved matching pipeline into an interactive visual prompting platform that allows users to segment objects classes of interest by highlighting representative objects in one or more reference images with coarse input (e.g., scribbles). With an improved computation complexity, a computing device may allow a user to iterate in real-time with the segmentation outputs, adding additional inputs on additional references to improve segmentation in case the model missed something.

The computing device may provide an interactive web interface that is designed to provide seamless interaction between the user and the object recognition (softmatcher) pipeline. The computing device may receive, from users, scribbles to any image to mark objects of interest. A visual prompting pipeline then highlights similar objects with precise segmentation masks on target images. If the user is not satisfied with the initial results, the user may provide, and the computing device may receive, iterative inputs (e.g., additional markings or removal of previously provided markings) to refine the outputs. In some aspects, the computing device may receive more prompts by converting output segmentation masks from a previous run into reference masks. The computing device may allow for user input to be classified into different categories, enabling creation of segmentation masks for multiple classes. A process of repeatedly adding and adjusting user inputs may provide users with a deeper understanding of how the model operates. By demonstrating the capabilities and limitations of the models, users may be taught to collaborate with the models more effectively, leading to better outcomes.

In some aspects, the computing device may interact with vision-language models (e.g., CLIP) to enable the use of text prompts in addition to the coarse user input. This may support a combination of visual and text prompts to refine masks and address scenarios where coarse input alone is not enough.

In an example implementation, a featurized (e.g., using a convolution neural network (ConvNet) or vision transformer (VIT)) set of reference image patches

$${x}_{i}^{r}$$

is identified in an annotated mask i∈M and a featurized set of patches

$${x}_{j}^{t}$$

is identified in an unannotated target image j∈T. The computing device (e.g., using a softmatcher algorithm) computes a soft matching score that represents a probability map on T as

$${p}_{j} = {〈 Softmax ( CosSimilarity ( {x}_{i}^{r} , {x}_{j}^{t} ) ) 〉}_{i} ,$$

where r is the pixels of interest as indicated in the reference image (indicate as the reference object of interest). The soft matching score pⱼ may be used to sample candidate points of the target image for annotation as an object of interest. CosSimilarity is a cosine similarity between

$${x}_{i}^{r} and {x}_{j}^{t}$$

and [symbol] [symbol] ᵢ an average (arithmetic or geometric) over the index i over reference patches.

Based at least in part on using soft matching scores, the computing device may identify objects of interest within target images using less computing power and with reduced latency compared to other techniques. For example, the computing device may identify objects of interest in small images (e.g., 448×448 pixels) with ⅙ of the latency of other techniques. For larger images, the improvement of latency increases. These improvements may support interactive and real-time workflows for object detection.

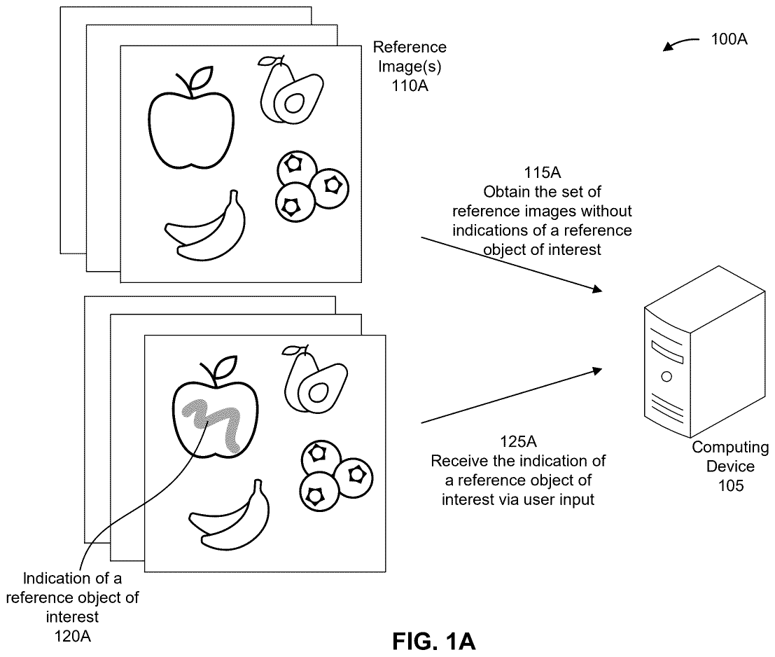

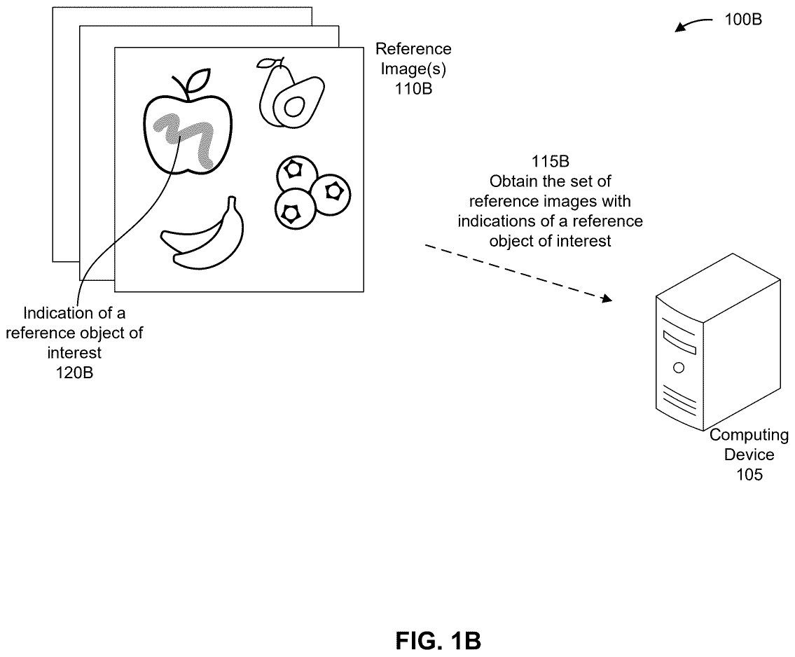

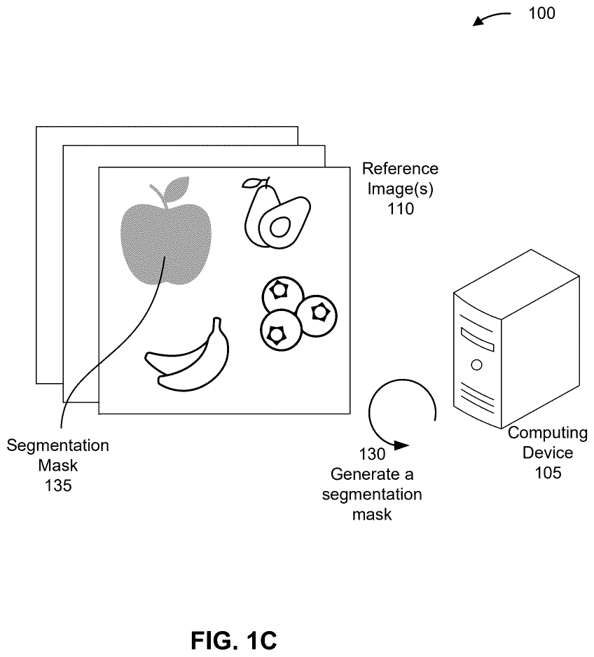

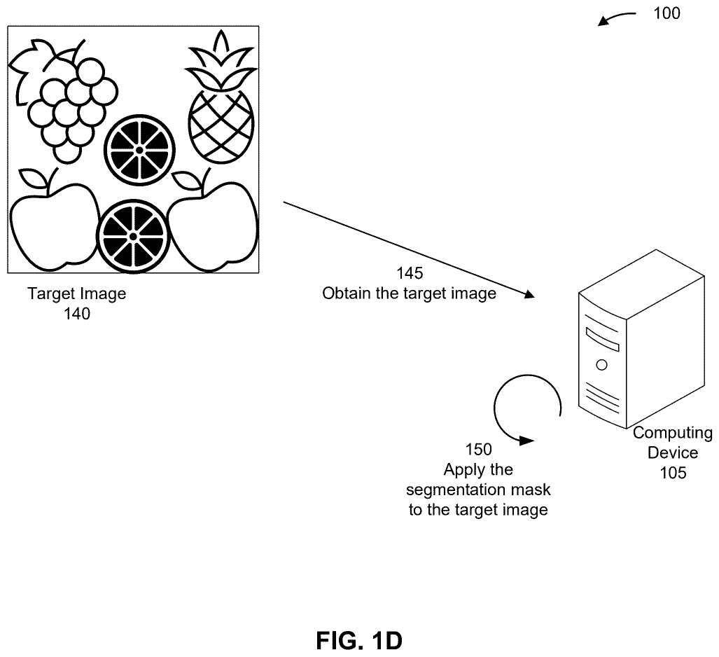

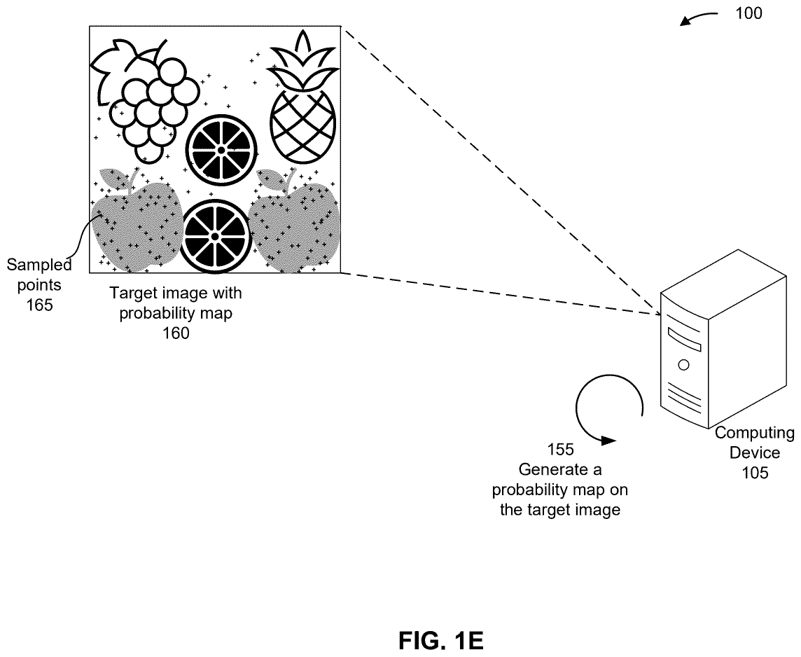

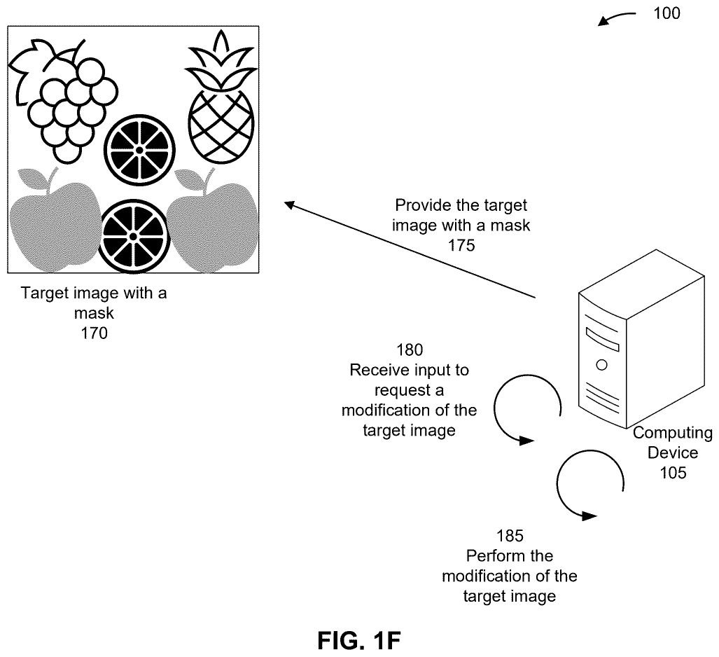

FIGS. 1A-1F are diagrams of an example implementation 100 (including options 100A and 100B) described herein. As shown in FIGS. 1A-1F, example implementation 100 includes a computing device 105 that may perform object recognition within images. In some aspects, the computing device 105 may be configured with a communication component to communicate with other computing devices. Additionally, or alternatively, the computing device 105 may be configured with an input component to receive input from a user or an output component to provide information to a user (e.g., a display or speaker, among other examples).

FIG. 1A shows an example implementation 100A as an option that may be separate or in addition to example implementation 100B of FIG. 1B. FIG. 1A includes one or more reference images 110A. As shown by reference number 115A, the computing device 105 may obtain the set of one or more reference images without indications of a reference object of interest. For example, the computing device 105 may receive the set of one or more reference images as an upload from a device (e.g., a personal device, such as a smart phone) or as a download from a device (e.g., a network device, a search engine, or an application server, among other examples).

In some aspects, a user or other computing device may provide an indication of a reference object of interest 120A on the one or more reference images 110A. For example, the computing device may receive input (e.g., from the user or from the other computing device) that coarsely indicates an area of the one or more reference images 110A as an object of interest. As shown in FIG. 1A, the indication of a reference object of interest 120A may be a scribble or other annotation on a reference image. In some aspects, the indication 110A may be considered a coarse input or coarse indication based at least in part on not providing a traced outline or full area indication of the object of interest. As shown by reference number 125A, the computing device 105 may receive the indication of the reference object of interest via user input. In some aspects, the computing device 105, or another computing device in communication with the computing device 105, may receive the input via a touch screen, a mouse, a stylus, a track pad, or other input device.

FIG. 1B shows an example implementation 100B where the one or more reference images 110B include, respectively, an indication of a reference object of interest 120B (“indication 120B”). As shown by reference number 115B, the computing device 105 may receive the one or more reference images 110B with the indication of a reference object of interest 120B already included with the reference images 110B. For example the computing device may include a remote computing device that receives the reference images 110B from a personal computing device that is local to a user.

As shown in FIG. 1C, and by reference number 140, the computing device 105 may generate a segmentation mask 135. In some aspects, the computing device 105 may generate the segmentation mask using an algorithm such as a SAM or or another prompted segmentation algorithm. In some aspects, the computing device 105 may provide an indication of the segmentation mask or identified objects of interest. In some aspects, the computing device 105 may receive feedback from a user or computing device to indicate accuracy of the segmentation mask. For example, the computing device 105 may receive input that changes a boundary of the object of interest or input that identifies multiple different objects of interest.

In some aspects, the computing device may generate the segmentation mask 135 using one reference image 110 or multiple reference images 110. In some aspects, the computing device 105 may use a relatively small number of reference images 110 (e.g., 1-10 reference images) to generate the segmentation mask 135. In this way, the computing device 105 may generate the segmentation mask 135 using a relatively small amount of input (e.g., relative to training a new object recognition machine learning model) and in a relatively small amount of time.

As shown in FIG. 1D, a target image 140 may include an object of interest that is not marked or otherwise indicated in the target image 140. As shown by reference number 145 the computing device 105 may obtain the target image 140. For example, the computing device 105 may obtain the target image 140 via a digital photo album, a camera application or other storage on the computing device 105, or another computing device (e.g., an application server or search engine).

As shown by reference number 150, the computing device 105 may apply the segmentation mask to the target image in an attempt to identify an object of interest. As shown in FIG. 1E, and by reference number 155, the computing device may use the segmentation mask to generate a probability map on the target image. FIG. 1E shows a target image with a probability map 160 and sampled points 165. As described herein, the computing device 105 may sample the target image 140 at sample points from the probability map. Sample points are grouped using clustering. In this way, the computing device 105 may determine probabilities of groups of pixels of the target image being an object of interest (e.g., a match to the object of interest in the one or more reference images 110).

As shown in FIG. 1F, the computing device 105 may generate a target image with a mask 170. The target image with the mask 170 may isolate (e.g., separate) one or more objects of interest within the target image with the mask 170. In this way, the computing device 105 may allow for the selection, editing, copying, or removal of the objects of interest from the target image with the mask 170.

As shown by reference number 175, the computing device 105 may provide the target image with the mask 170 to a user or to another computing device. For example, the computing device may provide the target image with the mask 170 to the user via a display coupled to the computing device 105 or via a display associated with another computing device. In some aspects, the computing device 105 may provide the target image with the mask 170 to another computing device to use for storage, machine learning training, autonomous vehicle operation, or other computer-based uses.

As shown by reference number 180, the computing device 105 may receive input to request a modification of the target image. For example, the computing device 105 may receive a request to change a color of the objects of interest (e.g., to create emphasis or for artistic purposes) or to change pixels that are not identified with the objects of interest (e.g., blurring or gray scaling, among other examples). As shown by reference number 185, the computing device 105 may perform the modification of the target image 140.

As indicated above, FIGS. 1A-1F are provided as an example. Other examples may differ from what is described with regard to FIGS. 1A-1F. The number and arrangement of devices shown in FIGS. 1A-1F are provided as an example.

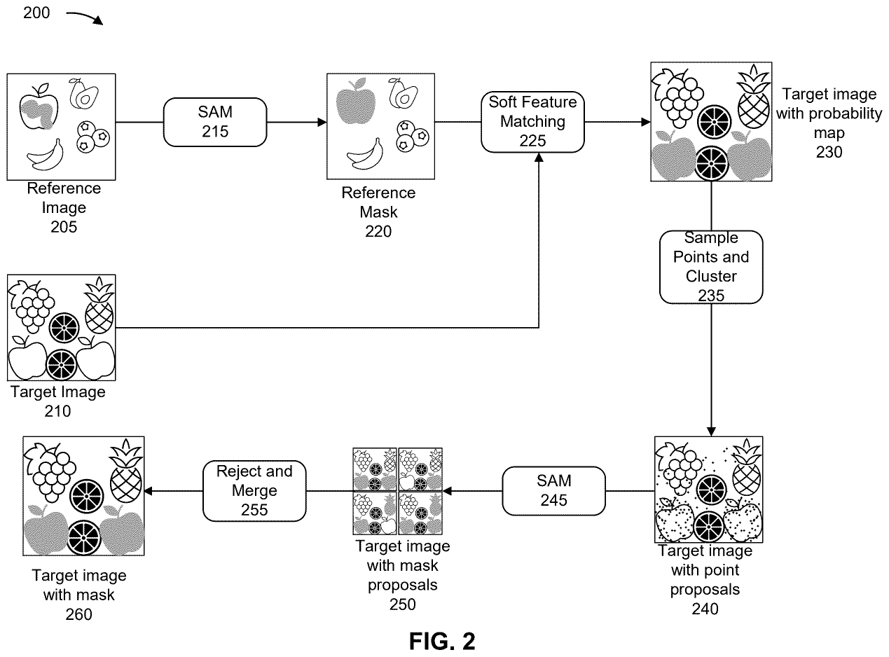

FIG. 2 is a diagram of an example implementation 200 described herein. The operations shown in FIG. 2 may be performed by a computing device (e.g., computing device 105 or another computing device).

As shown in FIG. 2, a computing device may receive a reference image 205 having an indication of an object of interest within the reference image 205. As shown in the reference image 205, the indication includes a coarse indication (e.g., a scribble) of the object of interest.

The computing device may also receive a target image 210 for identification of the object of interest. In some aspects, the target image 210 may be an inexact match to the object of interest. For example, an apple of the reference image 205 may be green and an apple of the target image 210 may be red or may have a different shape from the apple of the reference image 205.

The computing device may apply a SAM 215 (or another prompted segmentation algorithm) to the reference mask 220 to identify the object of interest within the reference image 205. For example, the SAM 215 may identify boundaries of the object of interest of the reference image 205 and characteristics of the object of interest, such as relationships between adjacent and proximate pixels.

As shown bin FIG. 2, the reference mask 220 and the target image 210 may be provided (e.g., to a soft feature matching module) for soft feature matching 225. The soft feature matching may use an optimal transport (OT) approach to identifying matching objects via the reference mask 220. The OT approach may be based at least in part on a quadratic cosine similarity matrix as a cost matrix for the object detection, as opposed to a cubic cost matrix used for other techniques. This may support the computing device to use a sequence of approximations for an efficient implementation of the matching procedure. For example, the computing device may use an entropic regularization, then consider the case of a large regularization limit where the solution to the OT problem converges to the geometric mean of softmaxed cosine similarity maps between individual reference features and target feature maps (where the averaging is conducting across reference features). This operation may have quadratically scaling complexity in the number of image patches. Additionally, the operation may support a scalable implementation by approximating the softmax computation of reference-target feature similarities through random Fourier features (RFF).

The soft feature matching 225 may provide input to a target image with a probability map, which provides an indication of likelihoods of pixels being associated with an object of interest within the target image 210.

The computing device may apply a sample points and clustering module 235 to the probability map 230 to generate a target image with point proposals 240. The point proposals may coarsely indicate areas of the target image 210 that may include an object of interest. The computing device may provide the target image with point proposals 240 to a SAM 245 (or another prompted segmentation algorithm) to segment portions of the target image 210 into objects that match the reference image based at least in part on the reference mask 220. The computing device may use the output of the SAM 245 to generate one or more target images with mask proposals 250.

The computing device may review or revise the mask proposals 250 for the target image 210 using a reject and merge module 255 to refine proposed objects of interest within the target image. The computing device may then generate a target image with mask 260.

As indicated above, FIG. 2 is provided as an example. Other examples may differ from what is described with regard to FIG. 2. The number and arrangement of devices shown in FIG. 2 are provided as an example.

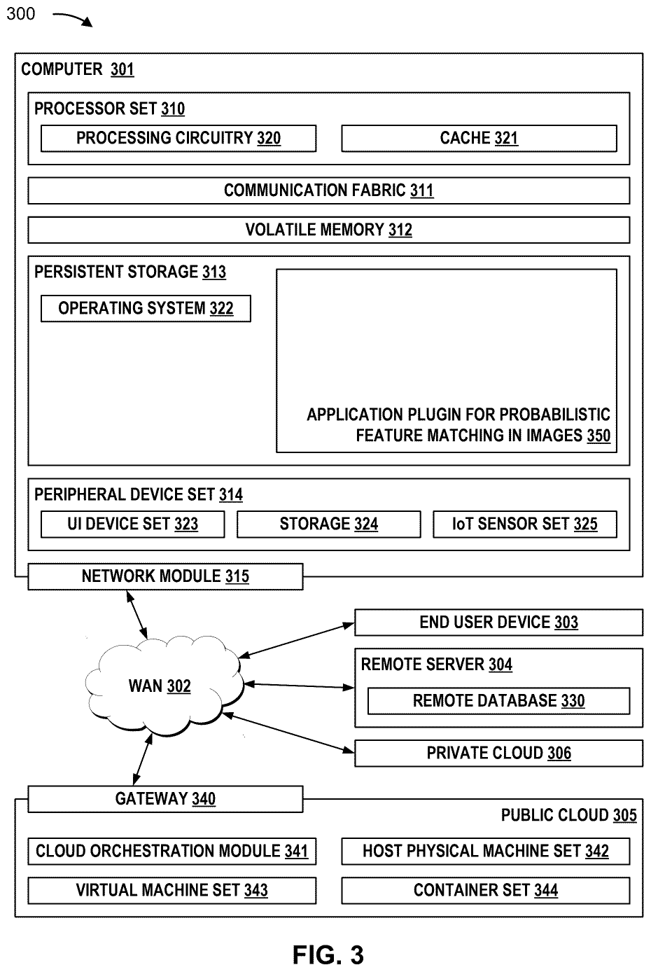

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as application for plugin probabilistic feature matching in images 350. In addition to application plugin for probabilistic feature matching in images 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and application plugin for probabilistic feature matching in images 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in application plugin for probabilistic feature matching in images 350 in persistent storage 313.

Communication fabric 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in application plugin for probabilistic feature matching in images 350 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

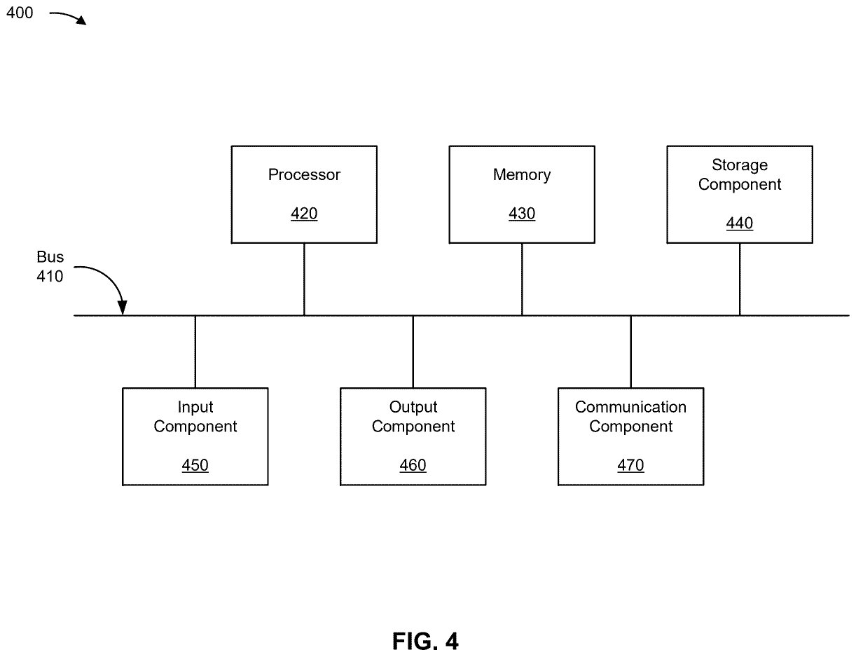

FIG. 4 is a diagram of example components of a device 400, which may correspond to the computing device 105, among other examples. In some implementations, the computing device 105 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may be a repository that stores a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

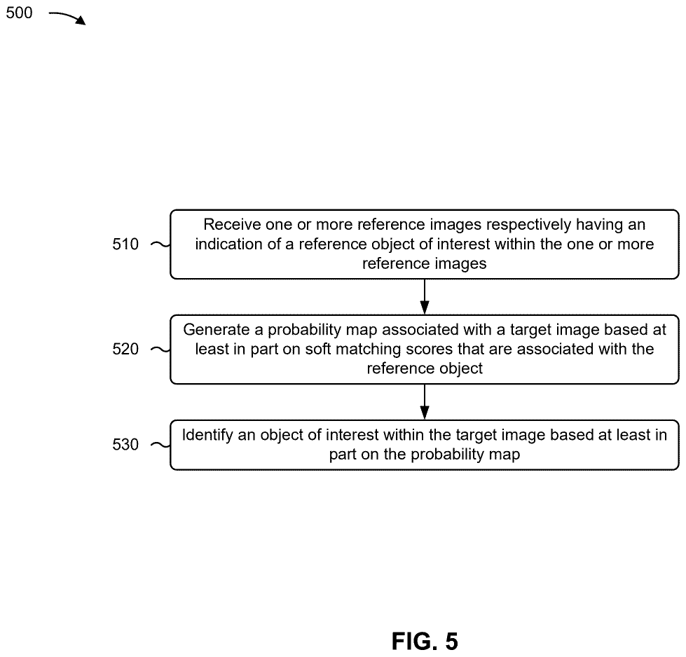

FIG. 5 is a flowchart of an example process 500 associated with probabilistic feature matching in images. In some implementations, one or more process blocks of FIG. 5 may be performed by a computing device (e.g., computing device 105). In some implementations, one or more process blocks of FIG. 5 may be performed by another device or a group of devices separate from or including the computing device, such as a network computing device, an application server, or a personal computing device. Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving one or more reference images respectively having an indication of a reference object of interest within the one or more reference images (block 510). For example, the computing device may receive one or more reference images respectively having an indication of a reference object of interest within the one or more reference images, as described above.

As further shown in FIG. 5, process 500 may include generating a probability map associated with a target image based at least in part on matching (e.g., soft matching) scores that are associated with the reference object (block 520). For example, the computing device may generate a probability map associated with a target image (e.g., one or more target images) based at least in part on matching (e.g., soft matching) scores that are associated with the reference object, as described above.

As further shown in FIG. 5, process 500 may include identifying an object of interest within the target image based at least in part on the probability map (block 530). For example, the computing device may identify an object of interest (e.g., one or more objects of interest) within the target image based at least in part on the probability map, as described above.

Process 500 may include additional implementations, such as any single implementation or any combination of implementations described below and/or in connection with one or more other processes described elsewhere herein.

In a first implementation, process 500 includes receiving, after identifying the object of interest, input requesting a modification of the target image, and performing the modification of the target image.

In a second implementation, alone or in combination with the first implementation, process 500 includes providing, after identifying the object of interest, an indication of the object of interest that is identified within the target image.

In a third implementation, alone or in combination with one or more of the first and second implementations, an algorithm associated with generation of the probability map has a computation complexity that is less than or equal to a product of a size in pixels of the target image and respective sizes in pixels of the reference objects.

In a fourth implementation, alone or in combination with one or more of the first through third implementations, identifying the object of interest comprises sampling candidate locations of the target image and identifying the matching (e.g., soft matching) scores to identify the object of interest.

In a fifth implementation, alone or in combination with one or more of the first through fourth implementations, process 500 includes obtaining one or more segmentation masks associated with the one or more reference images based at least in part on the indication of the object of interest, wherein the matching (e.g., soft matching) scores are based at least in part on application of the one or more segmentation masks to the target image.

In a sixth implementation, alone or in combination with one or more of the first through fifth implementations, obtaining the one or more segmentation masks comprises applying a pretrained segmentation model.

In a seventh implementation, alone or in combination with one or more of the first through sixth implementations, process 500 includes receiving an input that indicates a requested modification of the one or more segmentation masks, and modifying the one or more segmentation masks based at least in part on the input.

In an eighth implementation, alone or in combination with one or more of the first through seventh implementations, process 500 includes receiving the indication of the reference object of interest after receiving the one or more reference images.

In a ninth implementation, alone or in combination with one or more of the first through eighth implementations, receiving the indication of the reference object of interest comprises receiving the indication of the reference object via user input.

In a tenth implementation, alone or in combination with one or more of the first through ninth implementations, receiving the indication of the reference object via user input comprises receiving the user input as coarse user input.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

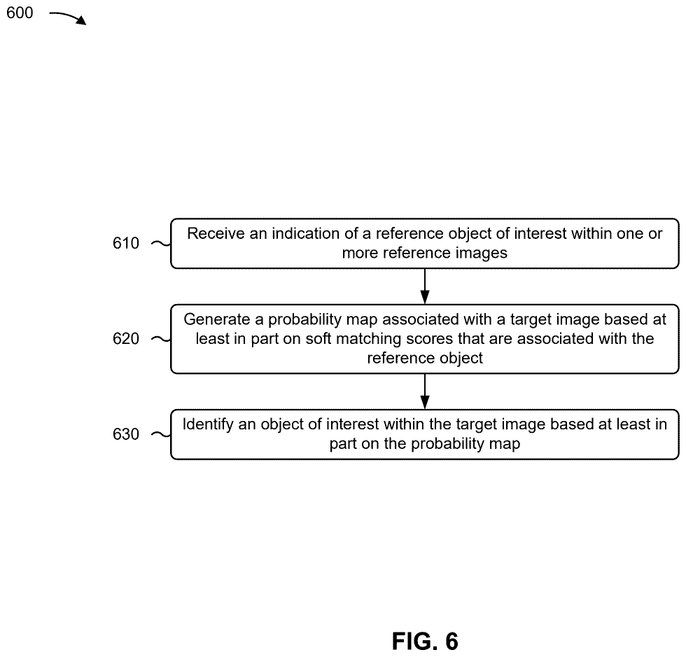

FIG. 6 is a flowchart of an example process 600 associated with probabilistic feature matching in images. In some implementations, one or more process blocks of FIG. 6 may be performed by a computing device (e.g., computing device 105). In some implementations, one or more process blocks of FIG. 6 may be performed by another device or a group of devices separate from or including the computing device, such as a network computing device, an application server, or a personal computing device. Additionally, or alternatively, one or more process blocks of FIG. 6 may be performed by one or more components of device 400, such as processor 420, memory 430, storage component 440, input component 450, output component 460, and/or communication component 470.

As shown in FIG. 6, process 600 may include receiving an indication of a reference object of interest within one or more reference images (block 610). For example, the computing device may receive an indication of a reference object of interest within one or more reference images, as described above.

As further shown in FIG. 6, process 600 may include generating a probability map associated with a target image based at least in part on soft matching scores that are associated with the reference object (block 620). For example, the computing device may generate a probability map associated with a target image (e.g., one or more target images) based at least in part on matching (e.g., soft matching) scores that are associated with the reference object, as described above.

As further shown in FIG. 6, process 600 may include identifying an object of interest within the target image based at least in part on the probability map (block 630). For example, the computing device may identify an object of interest (e.g., one or more objects of interest) within the target image based at least in part on the probability map, as described above.

Process 600 may include additional implementations, such as any single implementation or any combination of implementations described below and/or in connection with one or more other processes described elsewhere herein.

In a first implementation, process 600 includes providing, after identifying the object of interest, an indication of the object of interest that is identified within the target image.

In a second implementation, alone or in combination with the first implementation, identifying the object of interest comprises sampling candidate locations of the target image and identify the matching (e.g., soft matching) scores to identify the object of interest.

In a third implementation, alone or in combination with one or more of the first and second implementations, process 600 includes obtaining one or more segmentation masks associated with the one or more reference images based at least in part on the indication of the object of interest, wherein the matching (e.g., soft matching) scores are based at least in part on application of the one or more segmentation masks to the target image.

In a fourth implementation, alone or in combination with one or more of the first through third implementations, process 600 includes receiving an input that indicates a requested modification of the one or more segmentation masks, and modifying the one or more segmentation masks based at least in part on the input.

In a fifth implementation, alone or in combination with one or more of the first through fourth implementations, receiving the indication of the reference object of interest comprises receiving the indication of the reference object via coarse user input.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

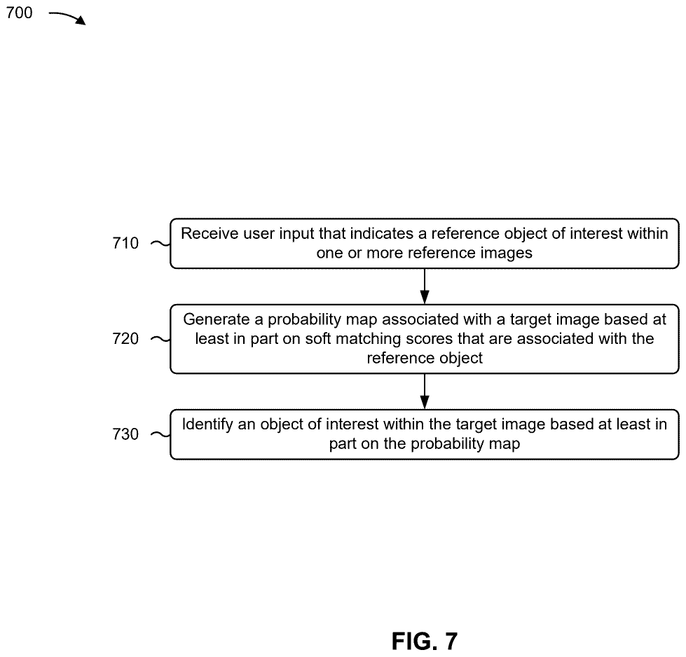

FIG. 7 is a flowchart of an example process 700 associated with probabilistic feature matching in images. In some implementations, one or more process blocks of FIG. 7 may be performed by a computing device (e.g., computing device 105). In some implementations, one or more process blocks of FIG. 7 may be performed by another device or a group of devices separate from or including the computing device, such as a network computing device, an application server, or a personal computing device. Additionally, or alternatively, one or more process blocks of FIG. 7 may be performed by one or more components of device 400, such as processor 420, memory 430, storage component 440, input component 450, output component 460, and/or communication component 470.

As shown in FIG. 7, process 700 may include receiving user input that indicates a reference object of interest within one or more reference images (block 710). For example, the computing device may receive user input that indicates a reference object of interest within one or more reference images, as described above.

As further shown in FIG. 7, process 700 may include generating a probability map associated with a target image based at least in part on soft matching scores that are associated with the reference object (block 720). For example, the computing device may generate a probability map associated with a target image (e.g., one or more target images) based at least in part on matching (e.g., soft matching) scores that are associated with the reference object, as described above.

As further shown in FIG. 7, process 700 may include identifying an object of interest within the target image based at least in part on the probability map (block 730). For example, the computing device may identify an object of interest (e.g., one or more objects of interest) within the target image based at least in part on the probability map, as described above.

Process 700 may include additional implementations, such as any single implementation or any combination of implementations described below and/or in connection with one or more other processes described elsewhere herein.

In a first implementation, process 700 includes providing, after identifying the object of interest, an indication of the object of interest that is identified within the target image.

In a second implementation, alone or in combination with the first implementation, identifying the object of interest comprises sampling candidate locations of the target image and identify the matching (e.g., soft matching) scores to identify the object of interest.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving one or more reference images respectively having an indication of a reference object of interest within the one or more reference images;
generating a probability map associated with a target image based at least in part on matching scores that are associated with the reference object; and
identifying an object of interest within the target image based at least in part on the probability map.

2. The method of claim 1, further comprising:
receiving, after identifying the object of interest, input requesting a modification of the target image; and
performing the modification of the target image.

3. The method of claim 1, further comprising:
providing, after identifying the object of interest, an indication of the object of interest that is identified within the target image.

4. The method of claim 1, wherein an algorithm associated with generation of the probability map has a computation complexity that is less than or equal to a product of a size in pixels of the target image and respective sizes in pixels of the reference objects.

5. The method of claim 1, wherein identifying the object of interest comprises:
sampling candidate locations of the target image and identifying the matching scores to identify the object of interest.

6. The method of claim 1, further comprising obtaining one or more segmentation masks associated with the one or more reference images based at least in part on the indication of the object of interest,
wherein the matching scores are based at least in part on application of the one or more segmentation masks to the target image.

7. The method of claim 6, wherein obtaining the one or more segmentation masks comprises:
applying a pretrained segmentation model.

8. The method of claim 6, further comprising:
receiving an input that indicates a requested modification of the one or more segmentation masks; and
modifying the one or more segmentation masks based at least in part on the input.

9. The method of claim 1, further comprising:
receiving the indication of the reference object of interest after receiving the one or more reference images.

10. The method of claim 9, wherein receiving the indication of the reference object of interest comprises:
receiving the indication of the reference object via user input.

11. The method of claim 10, wherein receiving the indication of the reference object via user input comprises:
receiving the user input as coarse user input.

12. A computer program product comprising:
one or more computer readable storage media, and program instructions collectively stored on the one or more computer readable storage media, the program instructions comprising:
program instructions to receive an indication of a reference object of interest within one or more reference images;
program instructions to generate a probability map associated with a target image based at least in part on matching scores that are associated with the reference object; and
program instructions to identify an object of interest within the target image based at least in part on the probability map.

13. The computer program product of claim 12, wherein the program instructions comprise:
program instructions to provide, after identifying the object of interest, an indication of the object of interest that is identified within the target image.

14. The computer program product of claim 12, wherein to identify the object of interest, the program instructions comprise:
program instructions to sample candidate locations of the target image and identify the matching scores to identify the object of interest.

15. The computer program product of claim 12, wherein the program instructions comprise program instructions to obtain one or more segmentation masks associated with the one or more reference images based at least in part on the indication of the object of interest,
wherein the matching scores are based at least in part on application of the one or more segmentation masks to the target image.

16. The computer program product of claim 15, wherein the program instructions comprise:
program instructions to receive an input that indicates a requested modification of the one or more segmentation masks; and
program instructions to modify the one or more segmentation masks based at least in part on the input.

17. The computer program product of claim 16, wherein, to receive the indication of the reference object of interest, the program instructions comprise:
program instructions to receive the indication of the reference object via coarse user input.

18. A system comprising:
one or more devices configured to:
receive user input that indicates a reference object of interest within one or more reference images;
generate a probability map associated with a target image based at least in part on matching scores that are associated with the reference object; and
identify an object of interest within the target image based at least in part on the probability map.

19. The system of claim 18, wherein the one or more devices are configured to:
provide, after identifying the object of interest, an indication of the object of interest that is identified within the target image.

20. The system of claim 18, wherein, to identify the object of interest, the one or more devices are configured to:
sample candidate locations of the target image and identify the matching scores to identify the object of interest.
